(19) United States
(12) Patent Application Publication
(10) Pub. No.: US 2005/0095324 A1
(43) Pub. Date: May 5, 2005

(54) Ready-to-eat food for infants or babies and method for its production

(76) Inventors: Ruben Santana Suarez, Ballwin, MO (US); Peter Zahner, Burghausen (DE); Hubert Reinl, Tuessling (DE)

Correspondence Address: WINSTON & STRAWN;PATENT DEPARTMENT, 1400 L STREET, N.W., WASHINGTON, DC, 20005-3502, US

(21) Appl. No.: 10/892,362

(22) Filed: Jul. 16, 2004

Related U.S. Application Data
(63) Continuation of application No. PCT/EP03/00287, filed on Jan. 14, 2003.

(30) Foreign Application Priority Data
Jan. 22, 2002 (EP) 02001521.0

(51) Int. Cl. A23B 4/00

(52) U.S. Cl. 426/119

(57) ABSTRACT

A ready-to-eat pre-packaged food for feeding infants or babies, in the form of a multi-component meal of a pasty or congealable consistency. This meal includes at least two components that can be visually differentiated, are unmixed and occupy at least two different volume segments of a product container or shape, and delimiting boundaries between the at least two components in the form of essentially vertical interfaces that are visible from above the container or shape as contours or boundary lines. Also disclosed is a method for producing a multi-component meal of a pasty or congealable consistency food product for feeding infants or babies,. The method includes separately preparing first and second pasty or congealable food components in free-flowing of dispensable form; filling a container with the first and the second food components in a manner such that the second component is placed in the container in a central position and the first component is placed in the container to surround the second component in a ring-like fashion at least near in the area of the visible top surface of the content of the cup-like product container; and sealing the product container with a lid.

### CROSS-REFERENCE TO RELATED APPLICATIONS

This application is a continuation of International application PCT/EP03/00287 filed Jan. 14, 2003, the entire content of which is expressly incorporated herein by reference thereto.

### BACKGROUND ART

This invention relates to a food for feeding infants and babies, that is ready to eat, that is sold in prepackaged form, and that constitutes a multi-component, pasty or gelatinous meal.

For feeding infants and babies, pasty ready-to-eat meals have been on the market for a long time; they are prepackaged, they can be stored without refrigeration, being shelf-stable products, and they are primarily sold in traditional baby food glass jars.

These conventional jars usually contain prepared meals composed of puréed ingredients that are ready to eat after they have been heated in a water bath. Baby food in small glass jars is available in numerous variations along different recipes and made from a variety of combinations of base materials. Many of the meals marketed are combination meals, for instance those that combine meat and vegetable components. However, since these ready-made meals are normally sold as an integrally mashed food, the relative amounts of the individual constituent components are predefined, the result being a composite taste that does not give the child an opportunity to separately experience the taste of the individual ingredients. Even the mother, as she feeds the child, is hardly in a position to clearly recognize the taste-related preferences of the child she is feeding, to correlate these with specific components of a meal and to respond to such preferences.

Products consisting of two different components layered one on top of the other cannot, or not easily, be placed on a spoon without being mixed in the process, since the bottom layer is not within direct reach. As a result, the layers are typically consumed one after the other or after they have been stirred into a uniform paste.

While the uniform pasty consistency of conventional baby food permits the creation of a variety of meals of different colors determined by the ingredients, it offers only limited possibilities for making the feeding process one of visual interest to the infant or baby being fed. A similar statement can be made for layered products.

The uniformly integrated nature of most of the traditional baby foods also sets certain limits in terms of the components that can be combined in the pasty meal due to the fact that certain ingredients, when thoroughly mixed, can compromise the taste or the shelf life of the resulting mixture. Thus, improvements in these type products are desired, and these are now provided by the present invention.

### SUMMARY OF THE INVENTION

The invention relates to a ready-to-eat food, prepackaged, for feeding infants or babies, in the form of a multi-component meal of a pasty or jelly-like consistency. The food is configured to allow the individual constituents of the meal to be combined in a novel fashion, thus making it possible during the feeding process to better recognize taste-related preferences and at the same time to make that process a visually interesting event for the infant or baby being fed.

One aspect of the invention is directed to a ready-to-eat pre-packaged food for feeding infants or babies, in the form of a multi-component meal of a pasty or congealable consistency. This meal is comprised of at least two components that can be visually differentiated, are unmixed and occupy at least two different volume segments of a product container or shape, and delimiting boundaries between the at least two components in the form of essentially vertical interfaces that are visible from above the container or shape as contours or boundary lines.

In one embodiment, at least one of the components is positioned in an essentially central location and is surrounded in essentially annular fashion by at least one of the other components. As desired, two different components or two visually distinguishable components can be used.

While the centrally located component can extend from an upper surface of the multi-component meal at least partially into the other component, it is preferred for the centrally located component to extend from an upper surface of the multi-component meal to a bottom surface of the product container. The centrally located component may have a visible cross-section in a circular, star-shaped, heart-shaped, triangular, polygonal or elliptical shape or a plant or animal shape. Also, the visually distinguishable components differ from one another by one or more of color, tonal brightness, transparency or texture.

In another preferred embodiment, the food is provided in combination with a container having a cup-shaped base and a lid or cover, where at least one of the cup-shaped base or lid is made of a transparent material, such as transparent plastic or glass. Alternatively, the cup-shaped base may be a cup that is provided with an opaque lid or cover foil which in turn is provided with an image of the multi-component meal in the cup or with a suitably indicative graphic illustration of the meal.

As desired, one or both of the components contain viscosity-enhancing additives or are whipped into a foamy condition so that the boundaries can be created. In addition, one or both of the components contain viscosity-enhancing additives in the form of thickeners or gelling agents, such as native or modified starches or gums.

The invention also relates to a method for producing a multi-component meal of a pasty or congealable consistency food product for feeding infants or babies which comprises: separately preparing first and second pasty or congealable food components in free-flowing of dispensable form; filling a container with the first and the second food components in a manner such that the second component is placed in the container in a central position and the first component is placed in the container to surround the second component in a ring-like fashion at least near in the area of the visible top surface of the content of the cup-like product container, wherein the at least two components that can be visually differentiated, are unmixed and occupy at least two different volume segments of the container, and delimiting boundaries are provided between the at least two components in the form of essentially vertical interfaces that are visible from above the container or shape as contours or boundary lines; and sealing the product container with a lid.

In this method, the first and second components can be simultaneously filled into the container by a dispensing system equipped with concentric nozzle openings, during which filling process the container and the dispensing system are moved relative to each other. For example, in a first step, the container can be partly filled with the first component and the second component subsequently injected into the first component, thus displacing the first component with the second component. For this, the second component can be introduced into the container from a dispensing system that utilizes a centered nozzle.

In other variations of the method, either of the first and second components, or both, is dispensed in heated form and the components are subsequently sterilized in the container by thermal in-pack sterilization. For this, either component can be dispensed at a temperature in the range from 70 to 95° C. and that upon cooling to room temperature at least one of the components assumes a firmer consistency. The components are preferably thermally sterilized by a Ultra High Temperature process prior to being filled into the container and that the filling of the container takes place under aseptic conditions.

### BRIEF DESCRIPTION OF THE DRAWINGS

Preferred examples of the food products of this invention are depicted in the following illustrations in which:

FIG. 1 is a perspective top view of a food product;

FIG. 2 is a bottom view of the food product in FIG. 1;

FIG. 3 is a cut-away bottom view of the food product in accordance with FIG. 1 showing, in contrast to FIG. 2, that the central core section does not extend all the way to the bottom of the container; and

FIG. 4 is a view as in FIG. 1, showing one of the possible variations in which the circular shape of the central section is replaced by a heart-shaped core.

### DETAILED DESCRIPTION OF THE PREFERRED EMBODIMENTS

In particular, the ready-to-eat food of the invention includes at least two components that can be visually differentiated, that are unmixed and that occupy at least two different volume segments of the total space in a product container. Delimiting boundaries are provided between the at least two partial fillings in the form of vertically extending, preferably curvilinear interfaces that are distinguishable on the product surface as contours or boundary lines. Preferably, at least one of the components is positioned in an essentially central location, surrounded in essentially annular fashion by at least one of the other components in at least one of the vertical spaces extending from the bottom to the top surface of the container contents.

The following will describe this invention in more detail in reference to a currently preferred form of implementation, in which one of the constituents is positioned in an “essentially central” location and is surrounded in “annular” fashion by the other component. In this particular case, the essentially vertical delimiting boundary between the minimum of two constituent components is in the form for instance of a continuous cylinder, but the more generally defining characteristic of this invention is intended to also include designs whereby some segments of the two components may at least in part be in contact with the container wall, meaning that the boundaries between the two components do not completely surround either component.

Nor are the terms “central” and “annular”, as used in the description of the preferred design version, to be understood as mathematical/geometric absolutes; instead, they imply “essentially central”, thus also allowing for an off-center placement, while “annular” may include rings of varying width, with an off-center opening, with irregular inner ring configurations resulting for instance from a contour of the central component that has a pictorial character such as the outline of an animal. It is thus the concept of vertical delineation that constitutes the basic definition of this invention.

The following description of a currently preferred form of implementation is not to be interpreted as limiting the scope of the patent to the design described below. It should nevertheless be sufficient if this invention is explained in some detail alone with the aid of one selected, preferred form of implementation. Other vertical space distributions between the two components should be obvious to those skilled in the art without requiring additional detailed descriptions.

A food according to this invention normally contains two visually distinguishable components: one of these components occupies part of the container space in a central location in a manner whereby it extends from the visible top surface of the multi-component meal into the body of the other component or completely through the latter all the way to the bottom of the product container.

The cross-section of the component that occupies the central space and that is visible on the surface of the multi-component meal is defined by a crisp contour which may for instance be circular, heart-shaped, triangular, polygonal, star-shaped or elliptical, or it may be in the form of a simple motif suggesting a crescent, a car, a flower or an animal such as a fish, a bear, a dog or the like. Generally, for more easily placing only one component on the spoon, a simple shape with basic contours is preferred. More complex outlines such as stars or flowers would be preferred whenever the emphasis is on visual appeal.

The ready-to-eat food per this invention may be a savory, salted dish whose ingredients include vegetables and/or meat or fish, or a sweet meal in which dairy products or milk-based items such as cottage cheese, yogurt, curd cheese, pudding or rice pudding components are combined with processed fruit such as stewed fruit or a sauce made from individual fruits or fruit combinations. The individual components may also be in whipped form.

To permit a clear distinction between the two components of a meal, so that the child being fed can see which part of the meal he or she is receiving and can thus associate a particular taste with one of the two components, and also to generate an interesting optical appearance, the two components can be made to look different for instance by virtue of their respective color and/or brightness and/or transparency and/or texture. Emphasis will be placed on arriving at the most attractive color combinations possible. It is not imperative that the two food components differ in color; they may equally well differ in color intensity or brightness or they may have a recognizably, tangibly different texture. Then again, one component may be opaque while the other component is more transparent, for instance in the form of a jelly or other gelatinous substance.

The food according to this invention is preferably sold in a container that readily allows recognition of its attractive content, or whose packaging is provided with a picture of the content or at least gives an indication of it. Whenever the food is sold in a container that typically consists of a cup- or dish-shaped bottom part preferably about 2 inches or less high, with a lid or cover foil, the cup and/or lid may be produced from a transparent plastic material allowing the visual recognition of the spatial distribution of the two components and perhaps of the fact that one of the components, constituting the central core, extends through the entire food product. Alternatively, glass containers may be used in lieu of plastic containers.

It is also possible, however, to sell the food per this invention in opaque or semi-opaque containers, especially plastic packages, and to replicate the appearance of the visible top surface of the food on the lid, or to invite attention to it through attractive pictorial artwork.

Given that the two food components in the meal per this invention are not separated by partitions, the desired separation of the individual components and the clear definition of the visual appearance make it necessary for the two components to have viscosity levels that prevent them from bleeding into one another even during subsequent thermal sterilization. If the two combined food components do not intrinsically have the required viscosity levels, viscosity-enhancing adjuvants may be added, such as thickeners or substances that bring about a more or less distinctive pectization of one or both of the components. Specifically, thickeners and/or gelling agents may be selected that are conducive to a firmer consistency of the components during and following the packaging process.

The thickening and/or gelling agents are preferably selected from among suitable native and/or modified starches, or one or both of the components are enriched with suitable hydrocolloids, especially vegetable gum such as carob bean flour, pectin, carrageen and similar known texturizing substances, to the extent that their use in foods for infants and children is safe.

There are also many components whose viscosity and firmness can be enhanced by whipping.

The multi-component foods according to this invention can be composed of the most diverse, mutually compatible individual ingredients. The following lists a few examples, with the obvious proviso that this enumeration is not and cannot possibly be complete.

For sweet food compositions, preparations containing milk-based products such as rice pudding and pudding stock, or preparations made with cottage cheese, yogurt, or sufficiently creamy curd cheese, can be advantageously combined with fruit components that may be in the form of stewed fruit or fruit sauce. Components that would normally be relatively fluid can be converted, preferably by the necessary amounts of gelling agents, into a non-dripping, for instance gelatinous phase. Also, many components can be whipped for higher viscosity and firmness.

Savory or salted meals on their part can be produced in the most diverse combinations. For these, meat or fish preparations are preferably combined with vegetables. Possible examples include poultry such as chicken or turkey meat combined with vegetables such as cooked spinach, mashed potatoes or creamed tomato. Equally eligible are rice dishes such as tomato and rice components, or food components derived from suitable types of pasta or from creamed corn. Fish components as well, for instance creamy salmon components, lend themselves well to these combinations.

During the feeding process the mother can use her spoon to pick up different amounts of the individual components, letting the child sample the taste of the different components and explaining what they are. Digging up the individual components with the spoon may also hold the attention of the baby or infant being fed, diverting it from other distractions.

Meals per this invention can be produced by essentially the same techniques that are used in the production of combination foods containing other types of ingredients and/or targeted at other consumer categories or purposes. For producing two-component meals according to this invention, the basic process involves the separate preparation of two pasty and/or congealable food substances in free-flowing or dispensable form and holding them in reservoirs from where they can be channeled, through suitable conduits, to a dispensing unit. The two food components are dispensed into the object meal container—typically a small tub, a cup or a dish—in a way whereby one of the components occupies the center of the container while the other component surrounds that central component in annular fashion at least in the area of the visible top surface of the content of the container. The term “annular” as used herein is not limited to smooth circular rings but is also intended to signify rings with irregular inner contours as in cases where they surround a heart- or star-shaped central core.

After the container is filled, it is sealed with a lid or an airtight cover foil.

As in the case of other traditional foods for infants and babies, the necessary shelf life is assured either by heat-sterilizing both components before they are packaged, for instance under the usual Ultra High Temperature- (or UHT-) conditions (e.g., 10 seconds at 150° C.) followed by packaging under aseptic conditions, or by subjecting the dispensed and packaged meal to so-called “in-pack sterilization” whereby the product is sterilized, in its sealed container, under the usual standard conditions (e.g., 50 minutes at 121° C.). If necessary, the shelf life can be extended further by the addition of suitable antioxidants, preferably those which are natural.

The packaging material used preferably comprises conventional, high-quality food-packaging plastics with the desired barrier-layer properties (e.g., oxygen and vapor barrier) as well as optical characteristics.

There are two basic ways to fill the containers:

If the filling process is to be a single-step operation, it employs concentric nozzles of an extruder, whereby the container is filled with two mutually separated, clearly delineated food components that have an appropriate minimum viscosity, while during the filling process the container and the dispensing unit are moved in the object direction relative to each other, meaning that either the nozzles or the dispensing units are lowered or raised and/or that the containers being filled are moved as needed.

In another form of implementation, the container is filled with the food per this invention in such fashion that the container is prefilled with one of the components in free-flowing form, after which the second component is added in a manner whereby the first component is displaced from that section of the container volume that is to be occupied by the second component.

This can be accomplished by lowering a tubular extruder nozzle of the desired cross section into the first component and, while injecting the second component into the body of the first component, retracting the nozzle, thus forming the desired composite of mutually delineated constituent volumes. Typically, this is how the central part is formed. Conceivably, however, this step could also be used to introduce an outer ring by means of a suitably designed annular nozzle, in which case the prefilled component would be displaced toward the center of the container content. As another feature especially in cases where a meal component is to be introduced in smaller relative quantities, it is inserted by injection under adequate pressure into the center of the prefilled first component without the injection nozzle being lowered all the way to the bottom of the container, the result being a central section that does not extend to the bottom. When the extrusion pressure for the second component is selected high enough, it may suffice to set the nozzle on the surface of the first component. Injecting the second into the first component will push the latter to the side and up around the nozzle that sits on it, whereby, as the nozzle is retracted or the container is lowered, the desired ring is formed.

When one of the components is prefilled, it is of course necessary in the prefilling process of the container to allow for the amount of the second component that is to be added in the following step, in that only enough of the first component is dispensed that when the next component is injected in the center of the first component, the combined content of the container reaches the desired final level. That level is preferably chosen so that the headspace in the filled container is about 5% or greater.

The relative proportions of the two components in the finished product are typically selected in such fashion that the central component constitutes about 30 to 40% of the total content. Of course, depending on the recipe, it may also be as low as 15% or less. In any event, however, its quantity will be such that the central component distinctly extends into the body of the other component rather than merely constituting a surface decoration.

In one implementation of the production method, both components are heated for the filling process in consideration of hygiene requirements and structural preferences.

Typical dispensing temperatures are in the range from 70 to 95° C. and especially above about 75° C. As soon as the container is filled with the two components, it is sealed and subjected to thermal “in-pack” sterilization (e.g., for 50 minutes at 121° C.), followed by cooling of the product to room temperature.

Alternatively, individual UFHT-sterilized components can be dispensed at room temperature, either simultaneously or sequentially, in which case the filling process takes place under aseptic, sterile conditions.

To that effect the meal components are preferably composed in such fashion that, as they cool off, they develop or at least retain the necessary viscosity. It is also important to make sure that the configuration created in the filling process is not destroyed again during the normally required thermal sterilization. Surprisingly, it has been found that different meal components for infants or babies can not only be filled into containers in one of the configurations described but that the configuration thus created can in fact be maintained even after thermal “in-pack” sterilization.

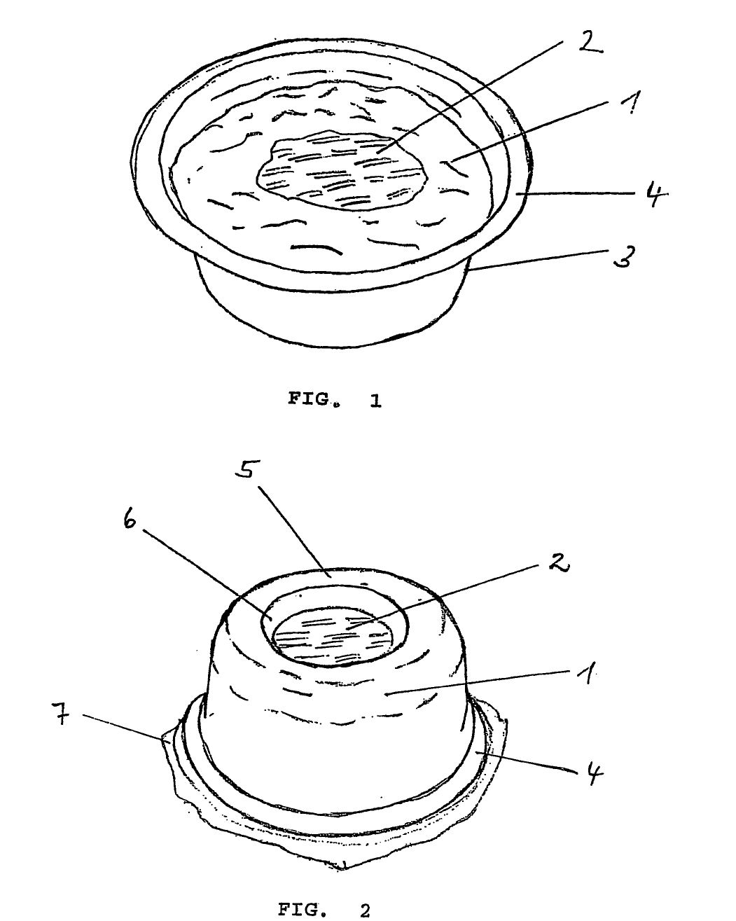

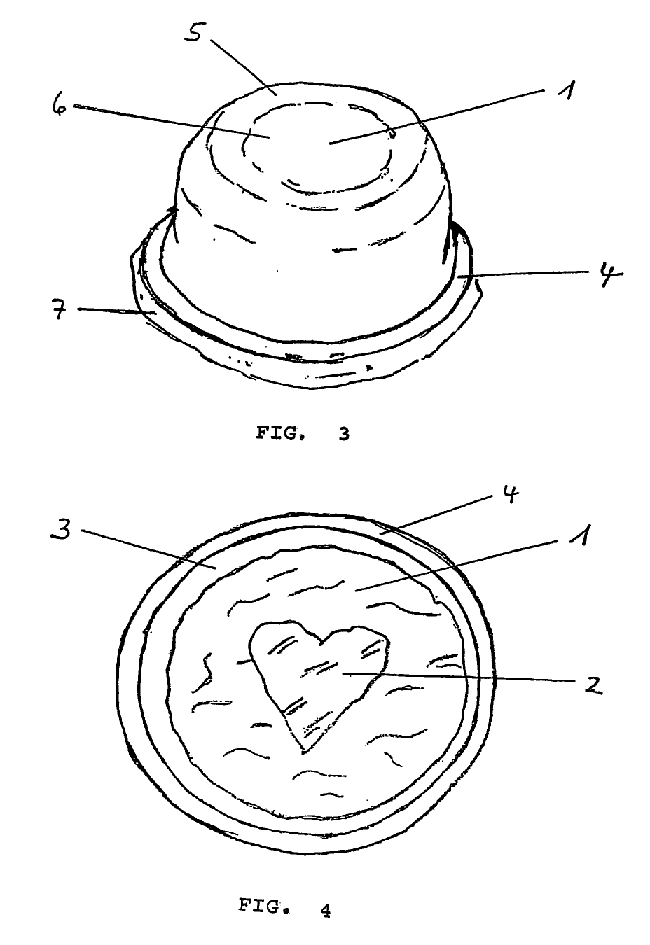

FIG. 1 is an illustration of one form of implementation of the food product according to this invention, showing a first component 1 and a central second component 2 in a container 3, as the product would be seen with the lid removed or through a transparent lid. The depicted container 3 is cup-shaped with a depth of about 2 inches and featuring a flange-shaped rim 4 that can accept a sealing foil. In this case, the central area occupied by the second component 2 is roughly circular, meaning that the central section is approximately cylindrical. As illustrated in FIG. 2, that section 2 can extend all the way to the bottom of the container and would also be visible from underneath through the bottom of the transparent container 3. The bottom 5 of the container 3 in the illustration features an annular footing and a recessed center 6. It sits on a schematically outlined sealing foil 7. As can be seen in FIG. 3, the central section constituted of the second component may also extend into the other component 1 only in an insular or plug-like fashion in which case only the component 1 is visible through the bottom 5, 6 of the container 3.

The central section 2 may have different contours attractive to children. FIG. 4, with a top view of a container 3 filled essentially as the one in FIG. 1, shows the example of a heart-shaped contour of the central section consisting of the second component 2.

1. A ready-to-eat pre-packaged food for feeding infants or babies, in the form of a multi-component meal of a pasty or congealable consistency, comprised of at least two components that can be visually differentiated, are unmixed and occupy at least two different volume segments of a product container or shape, and delimiting boundaries between the at least two components in the form of essentially vertical interfaces that are visible from above the container or shape as contours or boundary lines.

2. The food of claim 1, wherein at least one of the components is positioned in an essentially central location and is surrounded in essentially annular fashion by at least one of the other components.

3. The food of claim 2, having two different components.

4. The food of claim 2, having two visually distinguishable components.

5. The food of claim 4, wherein the centrally located component extends from an upper surface of the multi-component meal at least partially into the other component.

6. The food of claim 5, wherein the centrally located component extends from an upper surface of the multi-component meal to a bottom surface of the product container.

7. The food of claim 2, wherein the centrally located component has a visible cross-section in a circular, star-shaped, heart-shaped, triangular, polygonal or elliptical shape or a plant or animal shape.

8. The food of claim 1, as a savory meal that includes a vegetable, meat or fish preparation.

9. The food of claim 1, as sweet meal that includes a milk-based or starch-based product or a fruit preparation.

10. The food of claim 1, wherein the visually distinguishable components differ from one another by one or more of color, tonal brightness, transparency or texture.

11. The food of claim 1, in combination with a container having a cup-shaped base and a lid or cover, where at least one of the cup-shaped base or lid is made of a transparent material.

12. The food of claim 11, wherein the cup-shaped base is made of transparent plastic or glass.

13. The food of claim 1, in combination with a container of a cup with an opaque lid or cover foil which is provided with an image of the multi-component meal in the cup or with a suitably indicative graphic illustration of the meal.

14. The food of claim 1, wherein one or both of the components contain viscosity-enhancing additives or are whipped into a foamy condition.

15. The food of claim 14, wherein one or both of the components contain viscosity-enhancing additives in the form of thickeners or gelling agents.

16. The food of claim 15, wherein the thickening or gelling agents contained therein are native or modified starches or gums.

17. The food of claim 1, selected from combinations of two differently colored components selected from the group consisting of rice pudding preparations/stewed fruit, cottage cheese preparations/puréed fruit, poultry meat preparations/creamy corn, poultry meat preparations/tomato-pasta preparations, poultry meat preparations/spinach preparations, poultry meat preparations/tomato-rice preparations; beef preparations/tomato paste; beef preparations/mashed potatoes; and salmon preparations/spinach preparations.

18. A method for producing a multi-component meal of a pasty or congealable consistency food product for feeding infants or babies which comprises:
separately preparing first and second pasty or congealable food components in free-flowing of dispensable form
filling a container with the first and the second food components in a manner such that the second component is placed in the container in a central position and the first component is placed in the container to surround the second component in a ring-like fashion at least near in the area of the visible top surface of the content of the cup-like product container, wherein the at least two components that can be visually differentiated, are unmixed and occupy at least two different volume segments of the container, and delimiting boundaries are provided between the at least two components in the form of essentially vertical interfaces that are visible from above the container or shape as contours or boundary lines; and
sealing the product container with a lid.

19. The method of claim 18, wherein the first and second components are simultaneously filled into the container by a dispensing system equipped with concentric nozzle openings, during which filling process the container and the dispensing system are moved relative to each other.

20. The method of claim 18, wherein, in a first step, the container is partly filled with the first component and the second component is subsequently injected into the first component, thus displacing the first component with the second component.

21. The method of claim 20, wherein the second component is introduced into the container from a dispensing system that utilizes a centered nozzle.

22. The method of claim 18, wherein either of the first and second components, or both, is dispensed in heated form and the components are subsequently sterilized in the container by thermal in-pack sterilization.

23. The method of claim 22, wherein either component is dispensed at a temperature in the range from 70 to 95° C. and that upon cooling to room temperature at least one of the components assumes a firmer consistency.

24. The method of claim 22, wherein the two components are thermally sterilized by a Ultra High Temperature process prior to being filled into the container and that the filling of the container takes place under aseptic conditions.
